(19) United States
(12) Patent Application Publication
(10) Pub. No.: US 2020/0345152 A1
(43) Pub. Date: Nov. 5, 2020

(54) NON-SLIP CUSHION

(71) Applicant: Jennifer Humble, Mantua, NJ (US)

(72) Inventor: Jennifer Humble, Mantua, NJ (US)

(21) Appl. No.: 16/866,220

(22) Filed: May 4, 2020

Related U.S. Application Data
(60) Provisional application No. 62/842,966, filed on May 3, 2019.

(51) Int. Cl. A47C 27/15; B32B 3/12; B32B 5/18; B32B 5/32; B32B 5/02; B32B 5/24; A47C 7/35; A47C 7/18; A47C 27/14

(52) U.S. Cl. CPC A47C 27/15; B32B 2266/06; B32B 5/18; B32B 5/32; B32B 5/024; B32B 5/245; B32B 5/026; A47C 7/35; A47C 7/18; A47C 27/146; A47C 27/148; B32B 2262/0276; B32B 2307/744; B32B 2479/00; B32B 3/12

(57) ABSTRACT

A non-slip cushion includes a layer of a honeycomb gel for diminishing high pressure areas to reduce pressure ulcers.

### CROSS-REFERENCE TO RELATED APPLICATION

The present application claims the priority of U.S. Provisional Patent Application 62/842,996, filed May 3, 2019, which is incorporated herein by reference.

### BACKGROUND OF THE INVENTION

### 1. Field of the Invention

The present invention relates to seat cushions for use by individuals.

### 2. Brief Description of the Prior Art

Seat cushions are well known, and typically provide both comfort to an occupant, as well as a decorative effect to the chair or other seating arrangement upon which they are deployed. A decorative effect can be achieved by choosing a specific shape and fabric covering for the cushion. Comfort can also be optimized by the selection of shape and fabric covering, and, in addition, by the choice of a filling material. Modern seat cushions are frequently constructed from a synthetic polymeric foam material, such as a polyurethane foam. The relative importance of the decorative effect and the comfort of the cushion frequently depend on the intended use of the seat. For example, modern reproductions of Eighteenth Century French furniture may employ costly, finely detailed fabrics for covering cushions while filling the cushions with a relatively stiff material to maintain a relatively rigid shape, while contempory reclining chairs intended for the family room may employ ease-to-clean leatherette fabrics as a fabric to cover the cushions, while the cushion interiors are formed from thick slabs of foam to provide comfort.

Cushions for individuals with compromised mobility present special problems. Such individuals, such as elderly residents of nursing homes, may find themselves seated for long periods of time in the same chair unable to significantly change how they are sitting without assistance from a caregiver. This situation may result in tissue damage, such as pressure ulcers. In addition, individuals with compromised mobility may not be able to prevent themselves from slipping out of a sitting position, possibly resulting in injury. As the proportion and number of elderly continues to increase, there is a continuing need for a seat cushion which both remains comfortable for a long period of time and which reduces the likelihood of injury resulting from slipping out of the sitting position.

### SUMMARY OF THE INVENTION

The present invention provides an improved seat cushion, and in particular a non-slip cushion including a first layer comprising a sheet of an elastomeric gel material. This first layer includes a plurality of open cells, with each cell bounded by an upstanding cell wall. The seat cushion also includes a second layer formed from a foam material. Preferably, the seat cushion also includes a non-slip covering for the layers. In one aspect, the present invention provides a non-slip cushion further comprising a third layer formed from a foam material, with the first layer being positioned in between the second layer and the third layer. Preferably, the foam material is a memory foam material. Preferably, the non-slip covering is impervious to aqueous materials. Preferably, the plurality of open cells is arranged in a honeycomb or lattice design.

In one presently preferred embodiment of the present invention, the first layer is provided such that when pressure is applied normally to a first cell wall, the pressure is distributed to cell walls neighboring the first cell wall. Preferably, the pressure is distributed differently after a predetermined threshhold pressure is exceeded.

In one presently preferred embodiment of the present invention, the ratio of maximum pressure to average pressure calculated from pressure mapping measurement, measured as the cushion is in use by an individual, ranges from 1.6 to 5.0, preferably from 2.0 to 4.6, and more preferably from 2.3 to 4.3, when the contact area ranges from 86 to 96 percent.

In one presently preferred embodiment of the present invention the maximum pressure as measured by pressure mapping when the cushion is under average load does not exceed 120 psi, preferably 100 psi, and more preferably 90 psi, when the contact area ranges from 86 to 96 percent.

In one presently preferred embodiment of the present invention, the average pressure as measured by pressure mapping does not exceed 50 psi, preferably 40 psi.

In one presently preferred embodiment of the present invention, at least a portion of the plurality of cells include a secondary support wall extending from one locus on the cell wall to another locus on the cell wall for transimitting elastic force between the cell wall loci.

In another presently preferred embodiment, the first layer comprises a first sublayer and a second sublayer, wherein the extent to which a normal force applied to a cell is transmitted to neighboring cells in the first layer differs from the extent to which a normal force is transmitted to neighboring cells in the second layer. Preferably, the extent to which a normal force applied to a cell is transmitted to neighboring cells is less in the first layer than in the second layer.

### BRIEF DESCRIPTION OF THE DRAWINGS

FIG. 1 is a schematic front elevational view of a first embodiment of the non-slip cushion of the present invention.

FIG. 2 is a schematic front elevational view of a second embodiment of the non-slip cushion of the present invention.

FIG. 3 is a schematic fragmentary front elevational sectional view of a honeycomb gel layer for use in a non-slip seat cushion of the present invention.

FIG. 4 is a schematic top fragmentary plan view of the honeycomb gel layer of FIG. 3 shown in a relaxed position.

FIG. 5 is a schematic fragmentary top plan view of the honeycomb gel layer of FIG. 3 shown with pressure applied to a portion of gel layer normal to the surface of the gel layer.

FIG. 6 is a graphic illustrating the pressure distribution in a non-slip cushion according to the present invention.

### DETAILED DESCRIPTION

The cushion of the present invention includes at least one layer formed from a polymeric gel material which serves to laterally redistribute pressure applied to the upper surface of the layer of polymeric gel material. The polymeric gel material preferably has a honeycomb-like structure, that is, the polymeric gel material preferably has a plurality of uniformly sized open cells arranged in a regular geometric patern, such as a plurality of circles, ovals, squares, rectangles, hexagons, triangles, octagons or the like, with adjacent cells sharing adjacent cell walls. The cell walls are preferably of uniform thickness, except in the corners, where the wall can be thicker to provide extra strength for ease of manufacture. The polymeric gel material can be formed in two or more sub layers having different geometries, and/or which sub layers are formed from materials having differing physical properties such as differing elasticities or yield points. For example, the polymeric gel material can be formed in an upper sublayer and lower sublayer, the upper sublayer and lower sublayer having open cells extending continuously from the top of the upper sublayer to the bottom of the lower sublayer, with a portion of the cells being provided with at least one additional wall extending from one locus on the cell wall to another locus on the cell wall. In one aspect, the additional cell walls are provided only in the lower sublayer, and thus serve to reinforce or stabilize the cell wall within the lower sublayer.

The non-slip cushion of the present invention is presently believed to function by redistributing applied pressure through the process of “column buckling”. The gel layer or insert is constructed of a dry-polymeric gel made in a lattice or honeycomb design with a number of open cells surrounded by cell walls. Each gel cell wall is capable of supporting only a load up to a predetermined threshhold, so that when the threshold is surpassed, the wall “buckles” under, this then passes the applied force to the walls of surrounding cells. This “buckling and weight passing” happens repeatedly as a normal force is applied, such as when an individual sits on the non-slip cushion, until the weight is evenly supported. The physical integrity of the gel layer is maintained because the lower sublayer includes reinforcing walls within the cells, spanning between portions of the cell walls, streghthening the lower sublayer. When the individual rises from the cushion, the collapsed cell walls return elastically to their initial conformation.

Advantageously, this action results in pressure points such as the ischium and coccyx buckling the cell walls of the cushion, without perceptible resistance while, the buttocks are supported evenly. The areas of the body that commonly develop pressure sores almost “float” within the cushion while the individual's weight is evenly distributed across the surface of the cushion.

Individual results may vary. Preferably, each individual with limited mobility is evaluated for likely pressure points, and the dimensions of the cushion and each of the layers within the cushion are sellected as appropriate for the individual.

Preferably, the non-slip cushion of the present invention is used in conjunction with a chair appropriate for the limited mobility individual.

The present invention provides a non-slip cushion which promotes safety by decreasing falls and providing pressure redistribution. The non-slip cushion is preferably constructed with soft anti-slip woven polyester textile covering creating an anti-slip surface on both sides. This design holds the cushion securely in place and decreasing an individual, such as a nursing home resident with decreased mobility from sliding or falling. The strong durable fluid-proof cover is easily cleaned. The cushion can be does not need Velcro straps or the like to help maintain the cushion in place on a chair, as the non-slip covering is provided on both the top and the bottom of the cushion. The gel layer provides cooling comfort and pressure redistribution. Preferably, the cushion is provided with a high density supportive foam base which prevents hammocking.

The textile cover can be, for example, 100 percent black polyester knit fabric (4.5 oz./yd.) covered with a black polyvinyl chloride resin, embossed with a dot patterned design (SN1200D, Estex Products, Inc., Holbrook, Mass.).

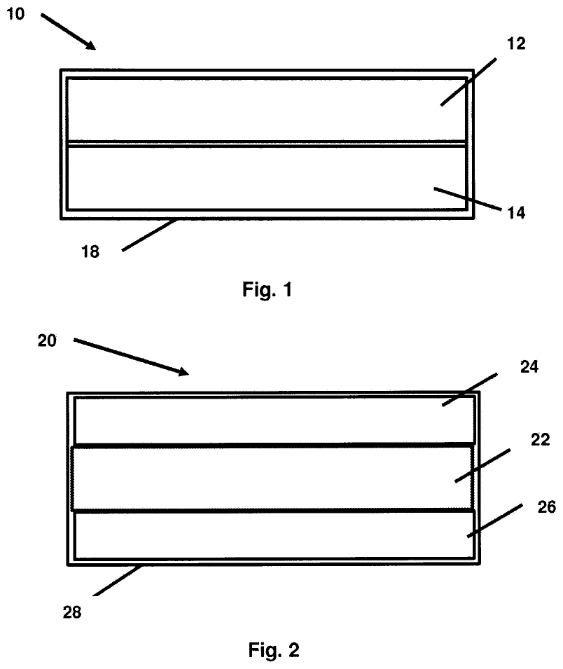

FIG. 1 provides a schematic front elevational view of a first embodiment of the non-slip cushion 10 of the present invention. The non-slip cushion 10 includes a first or upper honeycomb-like gel layer 12 positioned on top of a second or lower layer 14 of a memory foam material. The first layer 12 and second layer 14 are covered with a non-slip covering 18 which is preferably impervious to water and aqueous solutions and suspensions.

FIG. 2 provides a schematic front elevational view of a second embodiment of the non-slip cushion 20 of the present invention. The non-slip cushion 20 includes a first or middle honeycomb-like gel layer 22 positioned between a second or lower layer 26 and a third or upper layer 24, the upper layer 24 and lower layer 26 being formed from a memory foam material. The layers 22, 24, 26 are covered with a non-slip covering 28.

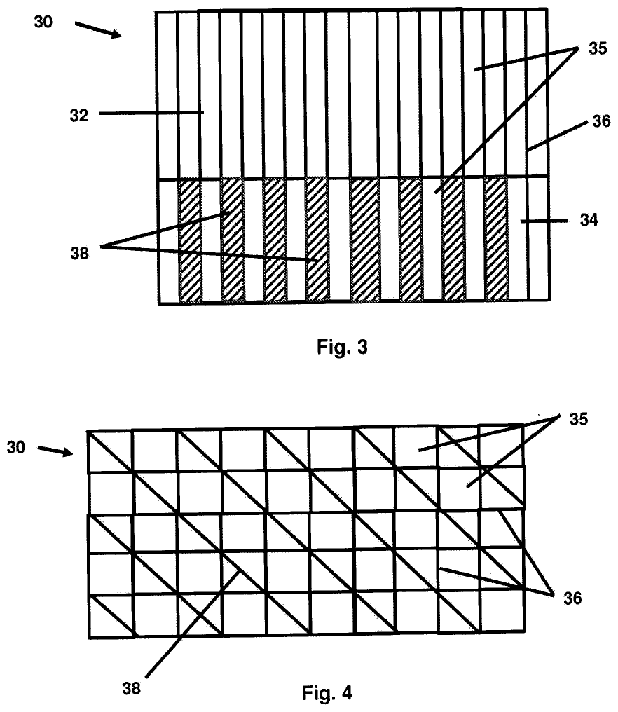

FIG. 3 provides a schematic fragmentary front elevational sectional view of a honeycomb-like gel layer 30 for use in a non-slip seat cushion of the present invention. The gel layer 30 includes an upper sub layer 32 on top of a lower sublayer 34. Cells 35 bounded by cell walls 36 extend continuously through the upper sublayer 32 and the lower sublayer 34. The geometry, thickness, and physical properties of the cell walls 36 are such that when pressure is applied on top of the gel layer 30, such as when an individual sits on a cushion including the gel layer 30, the cell walls 36 in the upper layer initially elastically oppose the applied pressure as the cell walls are compressed. However, when a predetermined pressure is exceeded, such as at a pressure point, the cell walls 36 collapse (not shown). The structural integrity of the gel layer 30 is maintained nevertheless, as the lower sublayer includes a plurality of reinforcing walls 38 extending from one side of the cell wall 36 to the other side of the cell wall 36. In practice, when an individual sits on a cushion including the gel layer 30, pressure is not uniformly applied accross the surface of the gel layer 30, as portions of the individual's anatomy will extend further into the gel layer 30 than others. The cell walls 36 under those portions will collapse to receive those portions when the predetermined pressure threshhold is exceeded, reducing the effective force opposing those portions, while the weight of the individual is at least partially redistributed to those portions of the gel layer 30 in which the predetermined threshhold force has not been exceded.

FIG. 4 provides a schematic top fragmentary plan view of the honeycomb-like gel layer 30 of FIG. 3 shown in a relaxed or unloaded position, as before an individual sits on a cushion including the gel layer 30. The gel layer 30 includes a plurality of cells 35 arranged in a lattice or honeycomb-like structure, with cell walls 36 surrounding each cell 35. The lower sublayer 34 includes a plurality of reinforcing walls 38 which extend from one corner of a cell 35 to the opposite corner of the cell 35. In this embodiment, the reinforcing walls 38 continue from cell to cell to form straight lines, and are arranged such that the cell 35 can be divided into a group with reinforcing walls and a group lacking reinforcing walls. The number, arrangement, and geometry of the reinforcing walls can be altered to provide the mechanical and elastic properties desired in the gel layer 30, or in some instances, such reinforcing walls 38 can be omited altogether.

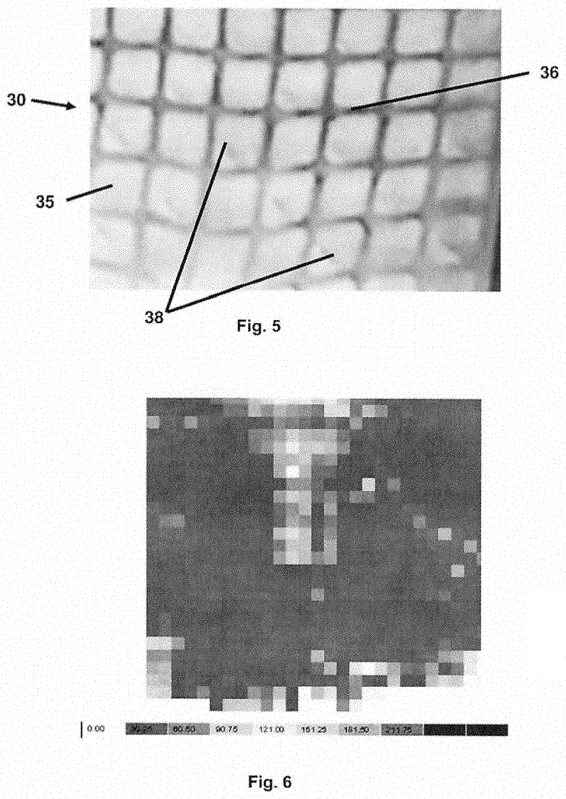

FIG. 5 is a schematic fragmentary top plan view of the honeycomb-like gel layer 30 of FIG. 3 shown with pressure applied to a portion of gel layer 30 normal to the surface of the gel layer 30, showing the geometry of the cells 35 being distorted by the application of pressure. Pressure is being applied adjacent the bottom, left-hand portion of the gel layer 30.

FIG. 6 is a graphic illustrating the pressure distribution in psi of a non-slip cushion according to the present invention measured using a pressure mapping instrument and software. In this example, the individual sitting on the cushion provided a contact area of 90.94 percent, the average pressure was calculated to be 31.95 psi, and the maximum pressure was measured to be 98.09 psi. The measured pressure is represented in the graphic by the depth of shading of color shade. It is believed that the relatively low level of measured pressure in the center back area of the pressure map reflects portions of the gel layer in which protruding portions of the anatomy of the sitting individual have collapsed the cell walls in the upper sublayer of the gel layer.

Various modifications can be made in the details of the various embodiments of the articles of the present invention, all within the scope and spirit of the invention as defined by the appended claims.

1. A non-slip cushion including:
a) a first layer comprising a sheet of an elastomeric gel material, the first layer including a plurality of open cells, each cell bounded by an upstanding cell wall,
b) a second layer formed from a foam material, and
c) a non-slip covering for the layers.

2. A non-slip cushion according to claim 1 further comprising a third layer formed from a foam material, the first layer being positioned in between the second layer and the third layer.

3. A non-slip cushion according to claim 1 wherein the foam material is a memory foam.

4. A non-slip cushion according to claim 1 wherein the non-slip covering is impervious to aqueous materials.

5. A non-slip cushion according to claim 1 wherein the plurality of open cells is arranged in a honeycomb-like design.

6. A non-slip cushion according to claim 1 wherein pressure applied normally to a first cell wall is distributed to cell walls neighboring the first cell wall.

7. A non-slip cushion according to claim 6 wherein the pressure is distributed after a predetermined threshhold pressure is exceeded.

8. A non-slip cushion according to claim 1 wherein the ratio of maximum pressure to average pressure calculated from pressure mapping measurement, measured as the cushion is in use by an individual, ranges from 1.6 to 5.0, when the contact area ranges from 86 to 96 percent.

9. A non-slip cushion according to claim 8 wherein the ratio ranges from 2.0 to 4.6.

10. A non-slip cushion according to claim 9 wherein the ratio ranges from 2.3 to 4.3

11. A non-slip cushion according to claim 1 wherein the maximum pressure measured by pressure mapping when the cushion is under average load does not exceed 120 psi when the contact area ranges from 86 to 96 percent.

12. A non-slip cushion according to claim 11 wherein the maximum pressure does not exceed 100 psi.

13. A non-slip cushion according to claim 1 wherein the average pressure measured by pressure mapping does not exceed 50 psi. A non-slip cushion according to claim 13 wherein the average pressure does not exceed 40 psi.

15. A non-slip cushion according to claim 1 wherein at least a portion of the plurality of cells include a secondary support wall extending from one locus on the cell wall to another locus on the cell wall for transimitting elastic force between the cell wall loci.

16. A non-slip cushion according to claim 1 wherein the first layer comprises a first sublayer and a second sublayer, wherein the extent to which a normal force applied to a cell is transmitted to neighboring cells in the first layer differs from the extent to which a normal force is transmitted to neighboring cells in the second layer.

17. A non-slip cushion according to claim 16 wherein the extend to which a normal force applied to a cell is transmitted to neighboring cells is less in the first layer than in the second layer.
